(19) United States
(12) Patent Application Publication
(10) Pub. No.: US 2015/0066544 A1
(43) Pub. Date: Mar. 5, 2015

(54) COMPUTER BASED METHOD FOR PREVENTING FINANCIAL LOSS DUE TO DISABILITY FOR PARTICIPANTS

(71) Applicant: Pension Advisory Group, Richmond, TX (US)

(72) Inventor: Paul D. Hinson, Sugarland, TX (US)

(73) Assignee: Pension Advisory Group, Richmond, TX (US)

(21) Appl. No.: 14/537,684

(22) Filed: Nov. 10, 2014

Related U.S. Application Data
(63) Continuation-in-part of application No. 12/573,020, filed on Oct. 2, 2009.
Application No. 12/573,020 is a continuation-in-part of application No. 12/501,326, filed on Jul. 10, 2009, now abandoned.
Application No. 12/501,326 is a continuation-in-part of application No. 10/908,419, filed on May 11, 2005, now abandoned.
(60) Provisional application No. 60/570,889, filed on May 13, 2004.

(51) Int. Cl. G06Q 20/02

(52) U.S. Cl. CPC G06Q 20/02; G06Q 40/08
USPC 705/4

(57) ABSTRACT

A system and method for preventing financial loss due to disability of participants in a retirement plan according to an insurance contract. One or more computers are programmed within a network to collate data from one or more databases according to the terms of an insurance contract. The insurance contract pays benefits into the retirement plan trust upon the disability of a plan participant. The benefits are treated as income or gain under the plan and are allocated to the participant's account. Benefits are distributable only upon attainment of the participant's normal retirement age. The administration of a retirement plan is carried out according to a computer based method and within a computer based system.

### CROSS REFERENCE TO RELATED APPLICATIONS

This application is a continuation in part of U.S. application Ser. No. 12/573,020 filed Oct. 2, 2009, which is a continuation in part of U.S. application Ser. No. 12/501,326 filed Jul. 10, 2009, which is a continuation in part of U.S. application Ser. No. 10/908,419 filed May 11, 2005, which claims the benefit of U.S. provisional application 60/570,889 filed May 13, 2004. Each of these applications are expressly incorporated herein by reference.

### FIELD

This disclosure, in a broad sense, is directed towards a method and system of insuring against financial loss due to disability. This disclosure further relates to certain methods of transmitting electronic funds on a networked computer system and disbursing the electronic funds. Additionally, the disclosure relates to networked computer systems and apparatuses involved in the disbursement of funds towards the goals of the disclosure. Further, the disclosure relates to a computer-based data processing method that will automatically generate the appropriate disability insurance premium amounts for a unisex-rated pension disability insurance contract that is designed to continue funding retirement plan contributions for Defined Contribution retirement plan participants if they become disabled while they are actively employed and covered by said disability insurance.

### BACKGROUND

There are many different methods of ensuring a person is able to receive retirement benefits by disbursement of these benefits by a bank or a trust. Unfortunately, these methods often rely on the use of mail, and other interactions that can cause errors and prevent a person eligible to receive retirement benefits from accurately doing so.

Due to the many different factors including managing multiple employees, types of jobs, types of disability and the like, there needs to be an improved system of helping these employees receive retirement benefits even in the event they become disabled. Likewise, there needs to be an improved system for changing disability insurance premiums for the fairness of the employer and a disability insurance company that can contribute to the retirement benefits. Due to an aging population, job changes, layoffs, or large numbers of new employees, constant or periodic electronic data transmissions should be sent to an actuarial device or computer to generate a premium based on new changes. To do so by hand or by telephone would be time consuming for large companies and introduce human error. An improved electronic method, system or apparatus can alleviate these problems.

Likewise, if an individual employee becomes disabled, there is need to correctly transmit this data to an electronic device set up to receive this information and to disburse funds to a device acting as a retirement trust account. The retirement trust account can thereby provide annuitized payments to the employee upon reaching retirement age instead of having a loss of retirement income due to disability. By associating the employee data with electronic funds, the trust is better able to keep track of the many employees that become disabled, regain their ability, and reach age of retirement.

Many different retirement plans exist on the market today. However, the defined contribution or “401(k)” plan currently is the most popular type of plan for the American worker to save money for retirement.

There are currently over 30 million individual 401(k) plan participants in the United States. These plans have over one trillion dollars in assets, which exceeds the total assets in all other types of plans combined. Approximately 88% of these plans permit the employee, to a limited extent, to choose and/or modify the particular securities in which the employee's money is invested.

A 401(k) retirement plan is one that is funded primarily by employee contributions from annual salary or wages, and which also may have an employer matching component whereby the employer will contribute a matching percentage of the employee's annual contribution to the plan, and further may include a discretionary profit-sharing component. A significant benefit of the 401(k) plan is its tax-deferred nature: not only are contributions deducted from the employee's pre-tax gross income, but gains from the investments in the plan also grow tax-free until such time as withdrawals are made.

Among the advantages of 401(k) plans are that since the employee does not pay any income tax on the percentage of his or her compensation that is contributed to the plan, such contributions effectively realize an immediate percentage “gain” defined by the employee's current tax bracket (which amount the employee would otherwise have to pay in income tax if the employee took the compensation in cash). Additionally, neither employer matching contributions nor employer discretionary profit-sharing contributions are subject to taxation when made to the plan. Further, the employee typically is able to choose among a number of different investment securities such as mutual stock funds, bond funds, cash management funds, and the like in which to invest the contributed funds, and normally he or she can move funds from one security to another thereby changing the relative percentage contributed to the different funds of the plan on an ongoing basis.

Still further, should the employee separate from his or her employer, unlike a pension or defined benefit plan, the employee's vested 401(k) funds may be “rolled over” either to a personal IRA (Individual Retirement Account) or to the 401(k) plan of a new employer.

Contributions to a 401(k), 403(b) or 457 plan cannot be made by an employee or an employer unless the employee is currently receiving pay, such as disability compensation from the employer. Typically, the employee must make the election to contribute to the plan from that pay before the pay has been made to and received by the employee.

Under IRC section 415(c)(3)(c) and Regulation sections 1.415-2(e)(3) and 1.415-4(g), compensation to a disabled employee is imputed at pre-disability levels if the employee is actually receiving some pay. Unfortunately, this is a very rare occurrence.

According to “Injury Facts” released in 2006 by the National Safety Council, in the United States alone, a fatal injury occurs in the home every 14 minutes. Additionally, a disability injury occurs in the home every four seconds Like injuries in the home, there is a motor vehicle crash every eleven minutes, and every 13 seconds there is an auto-related disability. Overall, in the home, in automobiles and everywhere else, over 400 Americans become disabled every 10 minutes.

Regarding the severity of disabilities, 43% of people age 40 and above will have a long-term disability event prior to age 65, according the JHA Disability FactBook, 2006 edition. The consequences of long-term disabilities are dire. A 35 year old white collar worker who suffers a disability lasting 90 days or longer will be out of work an average of about six years.

One problem with current 401(k) plans occurs when an employee becomes disabled, e.g. as a result of injury or illness, and is no longer able to work either permanently or for an extended period of time. During this period of disability, the employee is not receiving regular compensation and therefore cannot continue to make contributions to the retirement plan from periodic paychecks. In fact, even if the disabled employee had available funds from which to make contributions to the retirement plan, such would normally not be permitted as the disabled employee is not an active worker and therefore would not be eligible to make ongoing contributions.

In other words, if an employee becomes disabled, the employee can no longer participate in the qualified retirement plan if the employee is not actively on the payroll of a company. Further, the employee is prohibited from making elective deferrals and the employer is prohibited from making contributions on the behalf of the employee.

Of course, many employers provide short term and long term disability insurance for their employees. Such insurance, however, typically provides only a fraction of the income received from the disabled employee's regular job, is usually considered to be taxable income if the employer has paid the insurance premiums on behalf of the employee, and is only payable during the period that the employee is disabled-which by definition is usually at time during which the disabled individual is also incurring significant additional healthcare related expenses. Consequently, such disability insurance does not make up for the loss of expected growth in the employee's retirement plan over the long term caused by disability, which may be tens of thousands of dollars or more depending upon the age of the employee at the time of disability and the expected normal retirement age.

Accordingly, there exists a need for systems and methods to implement improvements in administration of deferred compensation contribution plans and in particular 401(k) plans to address the potentially staggering loss caused by a long-term disability.

In particular, a computer network system for administering a retirement plan financial product is needed that includes a disability insurance contract that is for the benefit of retirement plan participants. A disability insurance contract insures a participant under a retirement plan against the inability to continue retirement plan contributions due to disability. Premiums due under the insurance contract are paid by the employer. The benefits paid under a disability insurance contract are paid into a separate trust and further allocated to participants′. Further, the benefits paid under the insurance contract are not distributable to the insured participant until the participant is eligible to receive plan distributions as a result of attaining normal retirement age as defined in the retirement plan.

### SUMMARY

The present invention solves the shortcomings of the prior art by providing a novel computer based system and method for administering a defined contribution retirement plan financial product that provides a complete retirement benefit to an employee at normal retirement age notwithstanding any long term disability of such employee during the span of his or her working career. The product also is designed to facilitate satisfaction of the fiduciary requirements set forth in ERISA Section 404(c) (29 U.S.C. §1104).

In particular, a computer network system for administering a retirement plan financial product is provided that includes a disability insurance contract that is for the benefit of retirement plan participants. A disability insurance contract insures a participant under a retirement plan against the inability to continue retirement plan contributions due to disability. Premiums due under the insurance contract are paid from funds in a trust. The benefits paid under a disability insurance contract are paid into the trust and further allocated to participants' accounts. Further, the benefits paid under the insurance contract are not distributable to the insured participant until the participant is eligible to receive plan distributions as a result of attaining normal retirement age as defined in the retirement plan.

Also contained within this disclosure is a method and system to compensate for lost opportunity to contribute pre-taxed money to a deferred taxation retirement plan as a result of disability of a plan participant.

Further embodiments of the disclosure pertain to a networked computer system configured to transfer information and electronic funds to a trust computer and disbursing the electronic funds from the trust computer based on at least one conditional event and at least one non-conditional event. This system comprises a user interface computer on the networked computer system, a processing computer, a second trust computer and either a financial services computer, a first trust computer, or a combination thereof.

In this system, a user interface computer initiated electronic data transfer to the processing computer with the data comprising an age of an individual, employment information of the individual, salary of the individual and optionally other data comprising disability morbidity rates, industry adjustment factors, job classification factors, cost of living adjustments factors, own occupation adjustment factors and state relativity adjustment factors or combinations thereof, results in a generation of premium amount by the processing computer according to a disability insurance contract. In this instance, the electronic data comprising the premium amount is sent as electronic data over the networked computer system to the user interface computer which is then sent as electronic data over the networked computer system to the user interface computer.

Still further, in this system embodiment, the premium amount sent over the networked computer system to the user interface computer results in a user interface initiated transfer of data comprising electronic funds equal to the premium amount to the processing computer, from either transfer of said electronic funds from a financial services computer holding a personal or business bank account, or by transfer of said electronic funds from a first trust computer.

In further aspects of this embodiment, the user interface computer initiates another electronic data transfer comprising a notification of a first conditional event to the processing computer causing a processing computer initiated data transfer of electronic funds to a second trust computer which then associates the electronic funds received with an account belonging to the individual. Optionally, in this embodiment, the user interface initiates another electronic data transfer comprising a notification of a second conditional event to the processing computer causing the processor to stop data transfer of electronic funds to the second trust computer.

Still further, in the aforementioned embodiment, the second trust computer initiates a disbursement of funds from the account upon the occurrence of a non-conditional event

In further embodiments, until the first conditional event occurs, there is a user interface computer initiated data transfer comprising electronic funds not associated with the premium amount to a retirement plan computer. Typically, the retirement plan computer electronically associates the electronic funds with the individual. Still further, the data comprising electronic funds transferred to the second trust computer is indexed in accordance with data comprising electronic funds with maximum contribution deferrals allowed to be made to said retirement plan computer if the first conditional event does not occur.

In the aforementioned embodiments, the first conditional event is a disability preventing the individual from being employed, the second conditional event is a return to employment by the individual, and the non-conditional event is the age at which individual is eligible to receive funds from the second trust as a result of reaching retirement age as defined by the disability insurance contract.

Certain other embodiments of the disclosure herein pertain to an apparatus configured to receive at least one electronic data stream and configured to disburse electronic data upon a non-conditional event.

In this embodiment of the apparatus, the data stream in some instances is a single data stream. In other embodiments, it is a plurality of data streams. In such instances wherein the data stream is a plurality of data streams, the data streams are received by the apparatus in intervals. The intervals, as non-limiting examples, can be sent every second, minute, hour, day, week, bi-monthly, monthly, quarterly, bi-yearly, yearly, and the like.

The data stream typically comprises electronic funds associated with an entity, age of the entity, and a date at which a non-conditional event will occur.

In further embodiments pertaining to the data stream received by the apparatus, the data stream is transferred from a processing computer configured to transmit the data stream to the apparatus upon a first conditional event, and if a second conditional event occurs, the processing computer ceases transmitting the data stream. As should be readily understood, cessation of the data stream upon a second conditional event ceases transmission of data stream transmitted in regular intervals. For example, if the processing computer transmitted the data stream every month, after the second conditional event, the processing computer would no longer transmit the data stream the following month. The notification that a first conditional event has occurred or that a second conditional event has occurred is via a user interface configured to transmit this information to the processing computer.

In order to transmit the at least one data stream to the apparatus, the processing computer first receives electronic funds from: the user interface, or a retirement trust computer configured to transmit electronic funds to the processing computer after receipt of data comprising an authorization to transmit said funds by the user interface, or a financial institution computer configured to transmit electronic funds to the processing computer after receipt of data comprising an authorization to transmit said funds by the user interface, or by a combination thereof.

In embodiments regarding the transfer of the electronic funds to the processing computer, these funds are transferred after the user interface first transmits data regarding the entity comprising environmental, biological and financial information to the processing computer.

Upon transmission of this aforementioned information to the processing computer, the processing computer runs an actuarial model based on the entity data, a disability insurance contract, and optionally other data comprising disability morbidity rates, industry adjustment factors, job classification factors, cost of living adjustments factors, own occupation adjustment factors and state relativity adjustment factors, or combinations thereof and generates a premium.

The user interface then sends the aforementioned electronic funds to the processing computer or authorizes the transmittal of these funds. Typically, the electronic funds are equal to the premium or correspond to the premium. For example, the electronic funds received by the processing computer may include the premium plus additional administrative fees.

In further embodiments regarding the data stream transmitted by the processing computer and received by the apparatus, the entity is an employee. In further instances, the first conditional event is the date on which the employee becomes disabled and is no longer able to work. The second conditional event is a date on which the employee is able to return to work. The non-conditional event is a date on which the employee is able to receive retirement. Still further, in the aforementioned embodiments, the entity data can comprise a number of different types of data. Typically, before the generation of the premium, the entity data provided includes age of the employee, type of employment and other pertinent information such as length of employment and the like, as well as financial information such as a salary.

### BRIEF DESCRIPTION OF THE DRAWINGS

FIG. 1 is a block diagram of an exemplary network that may incorporate the systems and methods described herein;

FIGS. 2A-B is a sample flow diagram of a method within this disclosure;

FIG. 3 illustrates an example of possible types of tabular input data used within a method and system within this disclosure;

FIGS. 4A-B illustrates an example of possible tabular data used within a method and system within this disclosure;

FIGS. 5A-D illustrates examples of tabular data pertaining to a computer system methodology within this disclosure;

FIGS. 6A-C illustrates an example of input and output data pertaining to a computer system methodology within this disclosure;

FIGS. 7 A-C illustrates an alternate example of input and output data pertaining to a computer system methodology within this disclosure;

FIG. 8 illustrates a flow chart of the networked method of the present invention; and

FIG. 9 illustrates an alternate flow chart of the networked method of the present invention.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure are able to be embodied in practice.

We mean and intend the following definitions and explanations to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “Covered Individual” means and refers to an individual for which the Employer has paid premiums in order that contributions will be made to a trust for the individual should he/she become disabled.

As used herein, the term “Monthly Income” means and refers to the monthly average of the employee's compensation considered eligible under the Retirement Plan. As of any date, the average is computed for the period after the employee became eligible for the Retirement Plan.

As used herein, the term “Occupation” means and refers to the Occupation of the Covered Individual as stated in the SCHEDULE, for which coverage was rated.

As used herein, the term “Participate” means and refers to that the Covered Individual is physically able to actively engage in the major duties of his or her Occupation as stated in the SCHEDULE.

As used herein, the term “Permanent Total Disablement, Permanently Totally Disabled or Permanent Total Disability” means and refers to the Covered Individual has suffered Total Disablement and that, as a result of the Accidental Bodily Injury or Sickness or Disease directly causing the Total Disablement, a Physician has certified that the Covered Individual is expected to continue to be Totally Disabled from his or her Occupation as stated in the SCHEDULE for the remainder of his or her lifetime.

As used herein, the term “Physician” means and refers to a doctor of medicine or osteopathy who is: 1. licensed to practice medicine and prescribe and administer drugs or perform surgery; and 2. legally qualified as a medical practitioner operating within the scope of his or her license in the state or jurisdiction where services are rendered.

As used herein, the term “employer” means and refers to the person or entity who applied for insurance in respect of the Covered Individual. The employer will pay the required premium. The Policy Holder must have a valid insurable interest or obligation to the Covered Individual as evidenced by an executed contract or other documentation defining such insurable interest.

As used herein, the term “Pre-existing Condition” means and refers to a condition for which: 1. medical advice or treatment was recommended by or received from a Physician during the six (6) month period preceding the Effective Date of this coverage; or 2. symptoms were present during the six (6) month period preceding the Effective Date of this insurance which would cause a prudent person to seek medical attention.

As used herein, the term “Retirement Account” means and refers to an account for Contributions under the Retirement Plan.

As used herein, the term “Retirement Plan” means and refers to the retirement plan of the employer.

According to the present invention, a retirement plan financial product includes a long-term disability insurance policy or contract as a component of the underlying plan.

In certain embodiments, the plan has a guaranteed issuance, wherein there is no individual underwriting for insurability. In other embodiments, the occupation of the employee is taken into account and there is individual underwriting for insurability. In certain cases wherein the occupation is taken into account, greater insurability is for white collar jobs and employees with low risk hobbies or activities. In other cases, wherein occupation is taken into account, there is less insurability for hazardous jobs such as a commercial diver or a commercial fisherman, or wherein the hobbies of the individual include flying a private plane, etc. In general, to calculate a premium, electronic databases are used to store vast amounts of data from personal health and age of the employee to type of work to type of recreational activity that could cause a disability. These databases are electronically stored in computer memory and accessed by a computer to generate a numerical value. This is accomplished at a more accurate rate and at a faster speed than could be accomplished by a non-electronic database and human calculations.

In general, to calculate the premiums for a disability retirement plan, electronic databases comprising vast amounts of information such as occupation, employee data, and the like can be accessed and used by a computer processor.

In certain embodiments of the invention, the owner and beneficiary of the long-term disability insurance policy is the retirement plan trust and not the individual participants or individual or group trusts set up outside the retirement plan.

According to the present invention, in certain embodiments, the premiums are paid by the employer and are tax deductible to the employer. In other embodiments, the payments are electronically withdrawn from the employer's trust. In certain embodiments, the trust is a 401(k) trust. However, it is contemplated that other types of trusts may be used that are not the retirement trust into which money is disbursed to the retired employee.

According to the invention, benefits of the retirement package are based on actual contributions (up to qualified plan limits). According to the invention, the benefits are deferred until normal retirement age.

In certain further embodiments of the invention, the disability insurance premiums are reported as income to the recipients; therefore, benefits are tax-free to participants at retirement up to their policy basis.

In particular, although the disabled recipient would not be classified as an active employee and therefore normally would not be eligible to make elective contributions to the retirement plan, in accordance with the present invention the benefits paid under the long-term disability insurance contract are designed to correspond to the elective deferral as well as employer contribution amounts that were being made to the plan by the recipient prior to disability. In this manner, the benefit is somewhat analogous to a “waiver of premium” benefit typically provided as a rider to conventional insurance contracts such as life insurance, wherein premiums due under the insurance contract are automatically paid upon the disability of the insured.

Certain further embodiments of the invention concern the computer system by which the insurance methods are executed.

Certain embodiments concern the improved method of fund disbursement as discussed above. In these embodiments, the methods rely on electronic apparatuses which are configured to specialized tasks. For example, a user interface computer can keep track of the hundreds or thousands of employees using disability retirement contracts to counteract the issues with employer contributions into employee retirement accounts when an employee is disabled. Further, the user interface computer can receive information from a processing computer that is set up to coordinate payments, receive data on premiums from a computer running an actuarial model, and transmit data comprising funds to a processing computer or authorize electronic fund transfer to the processing computer from either a bank account on a financial services computer associated with the user interface or from an employer retirement trust account computer.

In further embodiments concerning the user interface computer, upon entering data regarding employee information, type of disability retirement contract selected, and the like, the data can be transmitted to the processing computer and then the processing computer can send data comprising the premium amount to the user interface.

While it is contemplated that the amount transferred or authorized for transfer by the user interface to the processing computer is equal to the amount of the premium, it is to be understood that “equal to” is sometimes imprecise and will include administrative fees and the like. However, the premium amount equal to that generated by the actuarial device is always paid from the aforementioned electronic funds.

As indicated above, the user interface computer can transmit electronic funds corresponding to the premium from an account associated with the user interface, or a trust account associated with the user interface computer. To eliminate error, such accounts have funds stored in electronic form. These funds are transferred to the processing computer.

Moreover, as indicated above, the processing computer receives a signal from the user interface of a conditional event wherein the employee becomes disabled and is no longer able to work for the company. In this instance, the processing computer will transmit an electronic data stream or other electronic funds to a trust computer or device configured to receive this data and disburse upon a non-conditional event.

Typically, the processing computer, which is configured to transfer the electronic funds to the fund disbursement device, such as a trust computer, transfers the electronic funds at periodic intervals. The intervals can be daily, weekly, bi monthly, monthly, quarterly, biannually, annually, and the like. This is typically done so that in the case of a second conditional event, no more electronic funds are transferred to the trust device.

Regarding the second conditional event, the second conditional event is the date when the employee is no longer disabled and can return to work for the company. In this case, the delivery of the information to the financial services computer and/or to the underwriter computer is the same as the notification of the first conditional event.

Regarding the disbursement device, the disbursement device receives the funds from the processing computer. The device is an electronic apparatus, computer or other similar device specifically configured to associate the funds with the disabled employee and to disburse the funds when the employee is able to receive the funds due to retirement age or the age at which the employee is able to receive retirement benefits.

Once the employee has reached retirement age or has reached the age wherein the employee is able to receive retirement benefits, which can be considered a non-conditional event, the device will electronically transfer the funds to an electronic bank account of the employee. Alternatively, the trust device can transmit the data to a printer to print out checks for the benefit of the employee.

In some embodiments of the invention, the computer system can comprise multiple subsystems within a computer or multiple computers operatively linked by a network. In such instances, the computers can have user interfaces such that data and electronic funds are properly transferred from one computer to another. The computers of the system include programs on computer readable and computer executable media. These computer programs include, but are not limited to: algorithms, software applications, including operations and procedures of the insurance method encoded as computer readable and computer executable program code in the form of a program product.

Still further, the program can have algorithms, software applications, including operations and procedures of the insurance method involving payment methods of a premium and any financing options generated by the program. In certain embodiments, the insurance method can be implemented in software, firmware or hardware, or a combination of each. In certain embodiments, the insurance method is implemented in software as an executable program code which comprises an ordered listing of executable instructions for implementing logical functions and which is executed by a server.

In practice, the user, such as the employer, would enter into the program from a computer. The employer would be able to contribute to the plan by using a credit card number, a banking account number, or an authorization to use the employer trust and other necessary information needed for payment. Alternatively, the computer program allows for future payment by financing, cash, check, or other valuable items to be delivered to an insurance agent or insurance company controlling the program.

Typically, the insurance method is implemented in a server having a processor. The processor is a hardware device for executing software including software stored in the memory and in the program unit, including a program encoded as the reimbursement insurance method. The processor can be any custom made or commercially available, off-the-shelf processor, a central processing unit (CPU), one or more auxiliary processors, a semiconductor-based microprocessor, in the form of a microchip or chip set, a macroprocesssor or generally any device for executing software instructions. The memory and the dynamic repository and the storage device or devices, and the plurality of databases can include any one of or a combination of volatile memory elements, including random access memory (including RAM, DRAM, SRAM and/or SDRAM) and non-volatile memory elements including read only memory (including ROM, erasable programmable read only memory, electronically erasable programmable read only memory EEPROM, programmable read only memory PROM, and/or compact disc read only memory CD-ROM or FLASH memory) magnetic tape, disk, diskette, cartridge, cassette and/or optical memory. The memory can have an architecture where various components are situated remotely from one another, but can be accessed by the processor.

In operation, in certain embodiments of the invention, the method disclosed herein defers paying disability benefits until retirement. In certain further embodiments, after satisfying an elimination period, benefits are paid by a retirement income trust after they are received by the employer's computer, the central computer which processes the premiums with access to at least one database, or the computer which holds the funds for the employer's trust. Still further, benefits can be paid by an underwriter, such as Lloyd's, into the retirement income trust.

In certain further embodiments, after five years of disability status, the underwriter, such as Lloyd's, will pay a lump sum into the retirement income trust. At retirement, a stream of income is payable directly by the retirement income trust to the participant to supplement his retirement income.

Further in operation, in certain embodiments, when calculating a covered individual's monthly benefit, the contribution for any month before the effective date of the group master policy will be the recipient's total contributions in the 12 months before the effective date of the group master policy divided by 12. If no contributions have been credited to the recipient's Retirement Account in the previous 12 months, then the monthly benefit is zero. While this embodiment contemplates monthly benefits, we contemplate that the benefits can be daily, weekly, bimonthly, every six months and so on in certain applications.

Still further in operation, in certain further embodiments, if the covered individual becomes disabled, the recipient's monthly benefit during the first year of disability remains the same as it was on the day he/she become disabled. While the recipient's disability continues, the recipient's monthly benefit will increase on each anniversary of the date the disability began. In certain embodiments, it will be 3% more than it was one year earlier, for example. If his/her disability ends and he/she returns to the eligible class, his/her monthly benefit will be calculated as defined.

Further in operation, premiums are electronically submitted by the employer. Premiums are tax deductible for the employer. The assets are held electronically in a retirement income trust. Benefits are based on actual contributions. Benefits are deferred until normal retirement age. There is no individual underwriting insurability.

In one embodiment, the benefit elimination period is 6 months. In another embodiment, the benefit elimination period is 12 months.

In one embodiment, the product is renewable. In another embodiment, there is a certain time for a lock on rates, for example, three years.

In yet another embodiment, there is a cost-of-living adjustment. As a non-limiting example, the cost-of-living adjustment can be 3%. Further, claims made in the first 12 months are equal to 3% of the recipient's current salary.

### Examples

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit or scope of the invention. The following Examples are offered by way of illustration and not by way of limitation.

There are numerous tabular information categories that serve as inputs to the technology of this disclosure. A pension disability insurance contract has a variety of optional features, including elimination periods, “own occupation” periods, and cost of living adjustments that apply to the benefit amounts that can be selected by a retirement plan trustee for the benefit of retirement plan participants as contemplated by this disclosure.

Based upon morbidity, expense and other assumptions in the pension disability insurance contract that are determined by an insurance company, resulting computer-generated insurance premiums will meet the insurance company's product designs, underwriting guidelines, and desired profit objectives. Additionally within this disclosure, trustees associated with Defined Contribution retirement plans fulfill their fiduciary responsibility under Section 404C of the Internal Revenue Code by evaluating and subsequently inserting the cost of a self-completing pension plan feature in their plans for the benefit of retirement plan participants.

In practice, the employer will use the user interface on the employer's computer to enter in to the computer data regarding the employee. The data is sent across a network to a data insurance processing computer suitable for storing and executing program code and will include at least one processor coupled directly or indirectly to memory elements through a system bus.

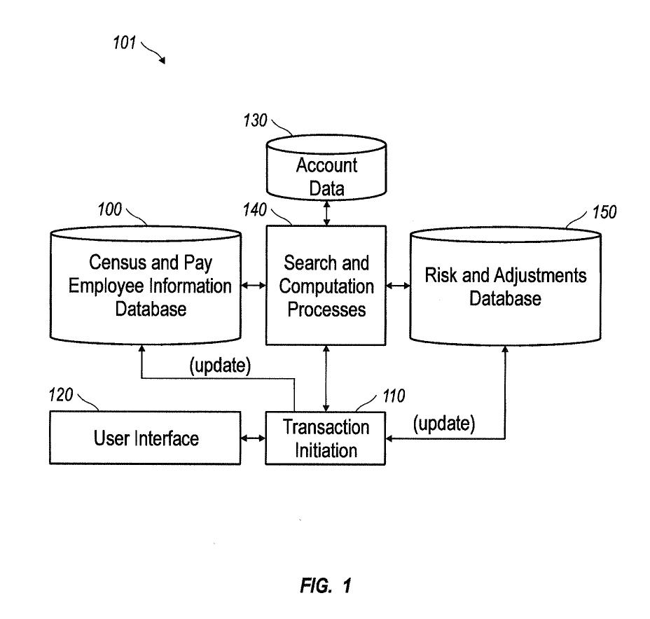

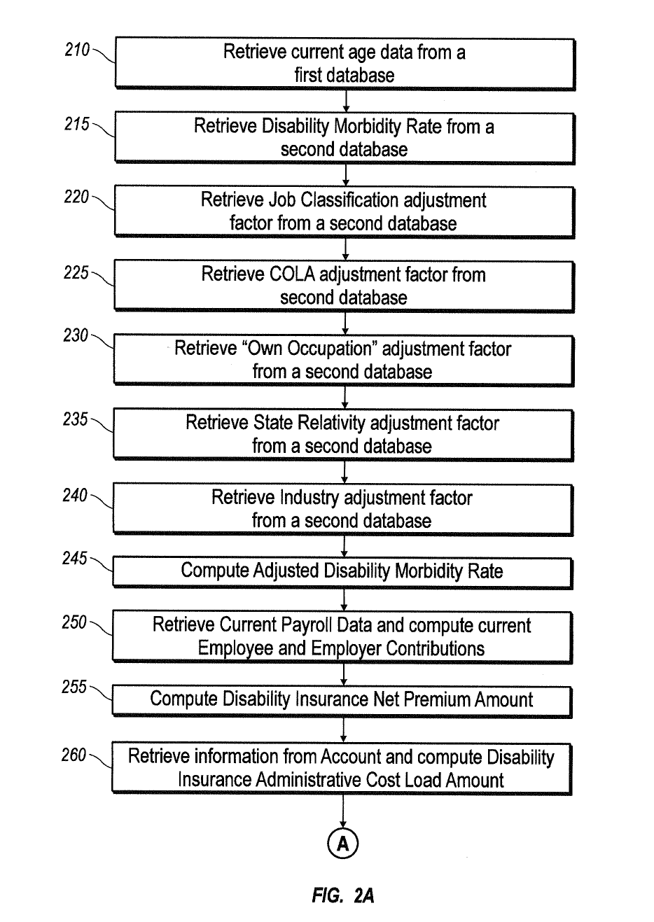

FIG. 1 shows a block diagram of a network within one possible embodiment of this disclosure. Within this disclosure, employee information for each of an entity's employees is stored within at least one data base 100 operatively connected to the insurance processing computer. The employee information includes at least the name, address, birth date, date of hire, occupation, and job classification for each employee. In the embodiment disclosed within FIG. 1, the database containing employee information 100 is called, in this example, a “Census and Pay” database 100. Those skilled in the art will also appreciate that the Census and Pay database 100 may comprise one or more sub-data bases. Updating the database operatively connected to the insurance processing computer occurs as a result of a transaction initiated 110 by a user, such as a manager of an insurance company, via a user interface 120 on the insurance processing computer. Alternatively, the information can be updated via the employer's computer. A user interface 120 may be a keyboard and/or mouse, though any mechanism by which a user may enter data will fall within this disclosure.

FIG. 1 illustrates that the insurance processing computer is operatively connected to another database entitled “Risk and Adjustments” database 150. The Risk and Adjustments database 150 can comprise one or more subset databases. At least some of the information that is stored in the Risk and Adjustments database 150 may be proprietary in nature, for example Disability Morbidity Rates, Industry adjustment factors, and Job Classification adjustment factors.

FIG. 1 shows still another database operatively connected to the insurance processing computer entitled “Account Database” 130. The “Account Database” 130 contains information which will be general to an insurance company as a whole, such as premium taxes, commissions, and administrative and claim adjudication expenses associated with pension disability insurance products offered by the insurance company. The information in the Account Database 130 will be established at the inception of a pension disability insurance product within this disclosure, though it may be updated according to the evolving circumstances of the insurance company that establishes and continues to offer the pension disability insurance product. For example, taxes imposed on premiums may change as laws change, and those skilled in the art will recognize that such information will need to be maintained as current.

The example within FIG. 1 discloses that search, retrieval and computation processes 140 are performed via computerized interaction coordinated by the insurance processing computer between and amongst the various databases 100, 130 and 150. The search, retrieval and computations 140 are performed by at least one computer program product using a data processing system like the one described hereinabove. As shown in FIG. 1, the search, retrieval and computations result from the occurrence of a transaction initiation 110. A transaction initiation 110 can be the result of a user prompting at the user interface 120. A transaction initiation could also occur automatically (not shown) based on the programming of the computer program product.

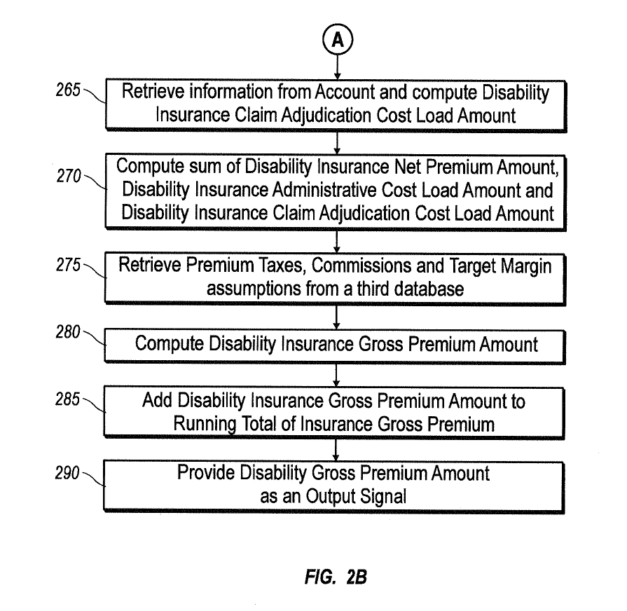

FIG. 2 depicts an exemplary method within this disclosure. The method will be performed at least one time each month for each employee participating in the pension disability insurance program. The computer program product disclosed will retrieve employee information 210 for a pension disability insurance program participant from a first database 100. The employee information may include a participant's name, address, date of birth, the date when the participant was hired (hire date), and the participant's occupation. The computer program product will search 215 a second data base 150 for relevant risk and adjustment factors. For example, the computer program product will retrieve 215 a Disability Morbidity Rate from a second database 150. The computer program product will retrieve 220 a Job Classification adjustment factor from a second database 150. The computer program product will retrieve 225 a Cost Of Living Adjustment factor (aka COLA) from a second database 130. The computer program product will retrieve 230 an “Own Occupation” adjustment factor from a second database 150. Those skilled in the art will recognize that the value for such a factor will depend on whether the participant is insured to recover against the financial impact of the inability to perform his or her particular own occupation due to disability, or whether the participant is insured against the financial impact of the inability to perform any occupation due to disability.

Continuing with the exemplary method shown in FIG. 2, the computer program product will retrieve 235 a value for a State Relativity adjustment factor from the Risk and Adjustments database 150. A State Relativity adjustment factor is an example of proprietary information, and those skilled in the art will recognize that a State Relativity adjustment factor allows for adjustment of insurance premiums charged based on the relative riskiness arising from residence in the various states within the United States of America. A computer program product will retrieve 240 an Industry adjustment factor from the Risk and Adjustments database 150. Those skilled in the art will recognize that an Industry adjustment factor allows for adjustment of insurance premiums based upon the relative risk associated with various industries that employers operate within. The computer program product in the exemplary method applies said above listed factors to the Disability Morbidity Rate and computes 245 an adjusted disability morbidity rate and stores the Adjusted Disability Morbidity Rate in memory. The computer program product retrieves payroll data from the Census and Pay database 100. The computer program product applies 250 the Adjusted Disability Morbidity Rate to the retrieved payroll data and thereby outputs Employer and Employee Contributions. The value of the Employer and Employee Contributions is stored in the Account Database 130. The computer program product applies the Adjusted Disability Morbidity Rate to the Employer and Employee Contribution data from the first database 100 and computes 255 a Disability Insurance Net Premium Amount.

Continuing with the example disclosed in FIG. 2, the computer program product retrieves 260 monthly administrative cost load information from the Account Database 130 and computes a Disability Insurance Administrative Cost Load Amount. The computer program product applies 265 a claim adjudication cost load to a Disability Insurance Net Premium Amount as described above and outputs a Disability Insurance Claim Adjudication Cost Load Amount. The computer program product computes 270 the sum of Disability Insurance Net Premium Amount, Disability Insurance Administrative Cost Load Amount, and Disability Insurance Claim Adjudication Cost Load Amount. The computer program product retrieves 275 account data from an Account database 130 such as values for premium taxes, commissions and target margin assumptions, and adds them in a sum. These terms will be well understood by those in the art. As shown in FIG. 2, the computer program product computes 280 an annual Disability Insurance Gross Premium Amount. The annual Disability Insurance Gross Premium Amount is the sum of the Disability Insurance Net Premium Amount, Disability Insurance Administrative Cost Load Amount, and Disability Insurance Claim Adjudication Cost Load Amount, all divided by (one minus a percentage of premium). The computed value for the annual Disability Insurance Gross Premium Amount is then output and can be stored in memory.

The computed value generated by the method for annual Disability Insurance Gross Premiums for all participants in a plan can be totaled and used to compute an annual Disability Insurance Gross Premium Amount for the plan, in other words to create a running total of insurance gross premium 285. A disability gross premium amount can then be outputted as a signal 290. A benefit of the system 101 within this disclosure is that an annual Disability

Insurance Gross Premium Amount can be used by the plan trustee on an ongoing or continuing basis to evaluate whether the pension disability insurance plan allows the trustee to meet its fiduciary duty to the retirement plan participants.

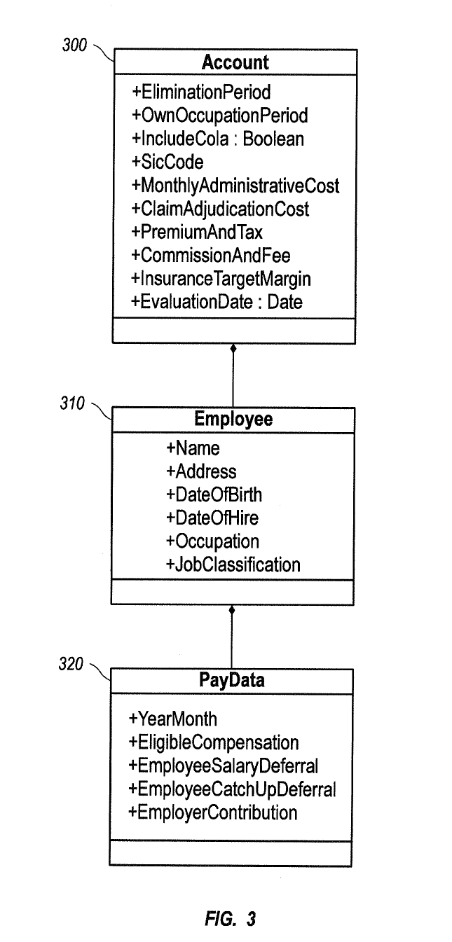

With regard to the exemplary types of data shown in FIG. 3, account data 300, employee data 310 and pay data 320, the following functions, processes, and calculations can be used to apply the basic principles within this disclosure to plan administrative processes: compute the current age of a participant; retrieve a relevant unisex morbidity rate from a computer database correlated to age and an elimination period (the period of continuous disability before benefits begin); retrieve a job classification adjustment factor from a computer database; retrieve a cost of living adjustment (COLA) factor from a database such as the Risk and Adjustments Database 150; retrieve an “Own Occupation” Adjustment Factor from a database such as the Risk and Adjustments Database 150; retrieve a State Relativity Adjustment Factor from a database such as the Census and Pay Employee Information Database 100 and retrieve an Industry Adjustment Factor based on Standard Industrial Classification (aka SIC) from a database such as the Risk and Adjustments Database 150.

Using data retrieved as described above, the system 101 can be used to compute an Adjusted Annual Unisex Disability Morbidity Rate, which can be stored in a database such as the Account Database 130 for later retrieval during a search and computation process 140. The data retrieved and stored according to the methods above can be used to calculate values for employee and employer contributions. Having done so, the system 101 multiplies the contributions by the adjusted morbidity rate. Said value divided by 100 is then a disability net premium. The method will then store the disability net premium in one or more databases, for example the Account Data database 130 for later retrieval. The system 101 will then compute Disability Insurance claim adjudication cost loads using the type of data shown in the exemplary Expense Assumptions Table 520 according to the methods disclosed (net premium times claims cost load, where claim cost load is defined by the user of the system 101). The system 101 can then be used to compute Disability Insurance claim adjudication cost loads using the type of data shown in the exemplary Expense Assumptions Table 520 according to the methods disclosed. The system 101 can then be utilized to compute the sum of the Net Premium and non-volume related expense data and this data will be stored in a database. The system 101 can then be used to compute an Annual Disability Insurance Gross Premium Amount using the type of data stored in Account Data 130 and shown in the example Expense Assumptions table 520.

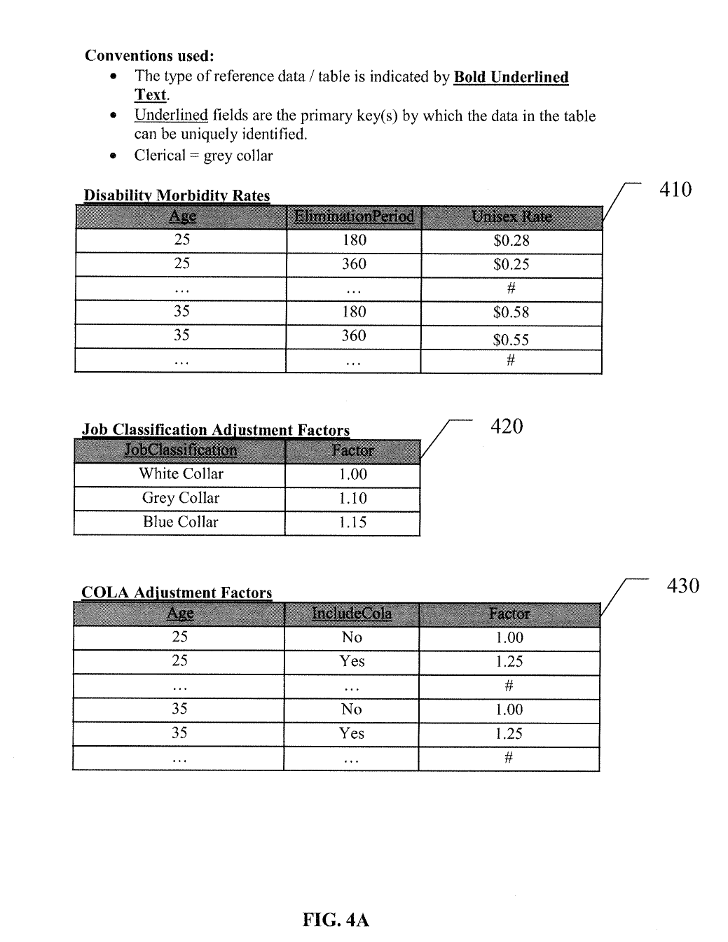

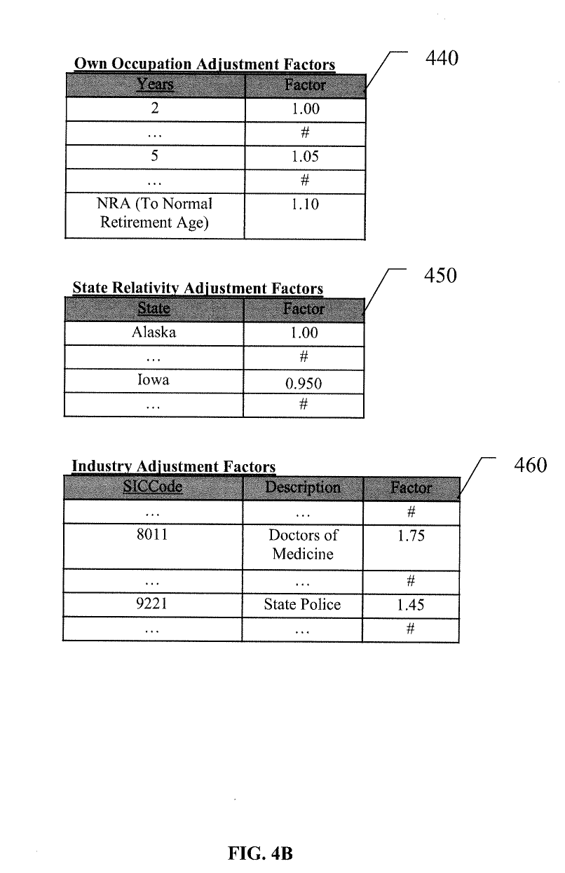

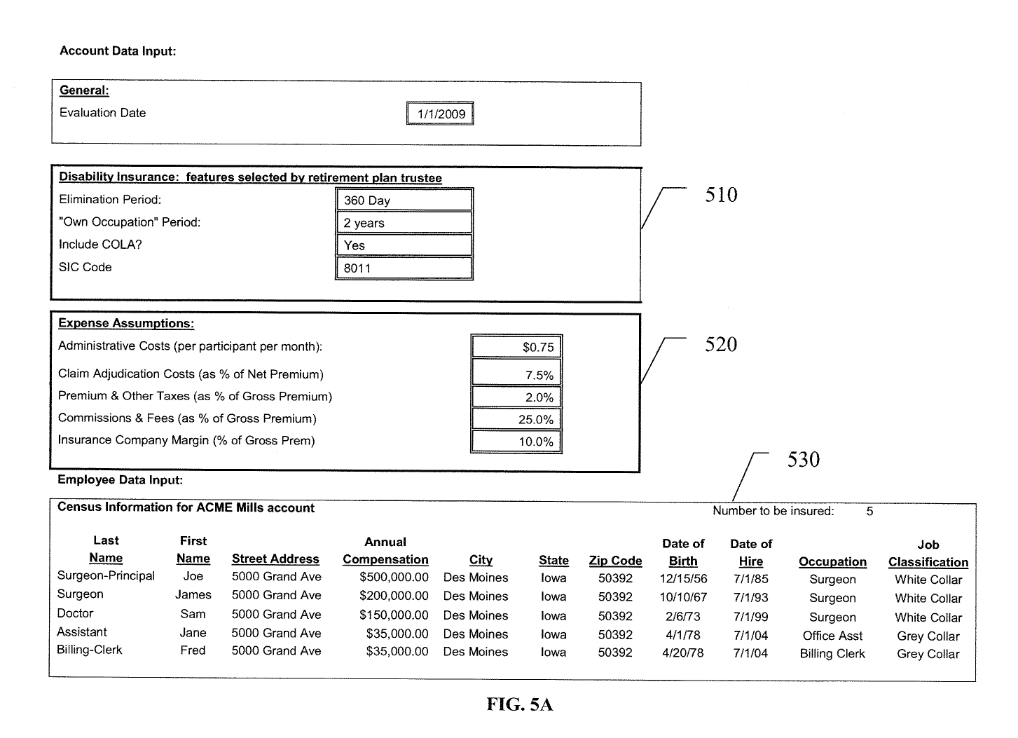

FIG. 4A contains three exemplary tables of information used in implementing the system 101 disclosed. The Disability Morbidity Rates table 410 shows possible disability morbidity rates based on age which are stored in a database like the Risk and Adjustments Database 150. The Job Classification Adjustment Factors table 420 shows exemplary job classification modifiers of the type that are stored in a database such as the Risk and Adjustments Database 150. The COLA Adjustment Factors table 430 shows exemplary cost of living adjustments data of the type that is stored in the Risk and Adjustments Database 150.

In FIG. 4B, the Own Occupation Adjustment Factors table 440 shows exemplary own occupation data of the type that is stored in the Risk and Adjustments Database 150. The State Relativity Adjustment Factors table 450 shows exemplary state relativity adjustment factors of the type that are stored in the Risk and Adjustments Database. In the example shown, it can be seen that Alaska (1.00) as a state of residence is considered to be of higher risk of disability than Iowa (0.95). The Industry Adjustments Factors table 460 shows possible SIC Codes and accompanying factors as described above.

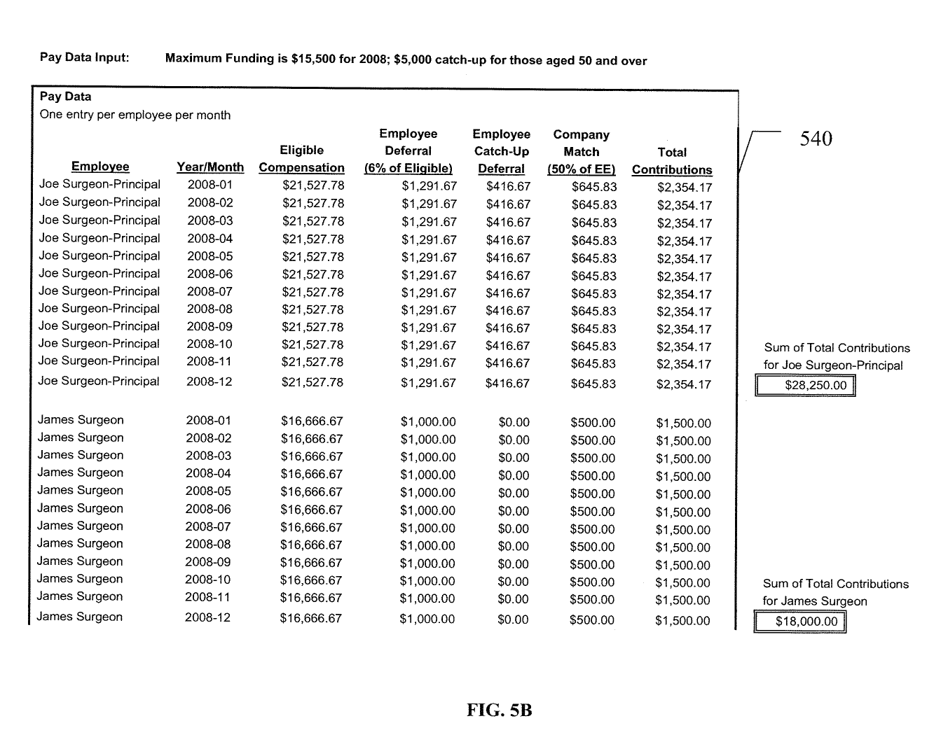

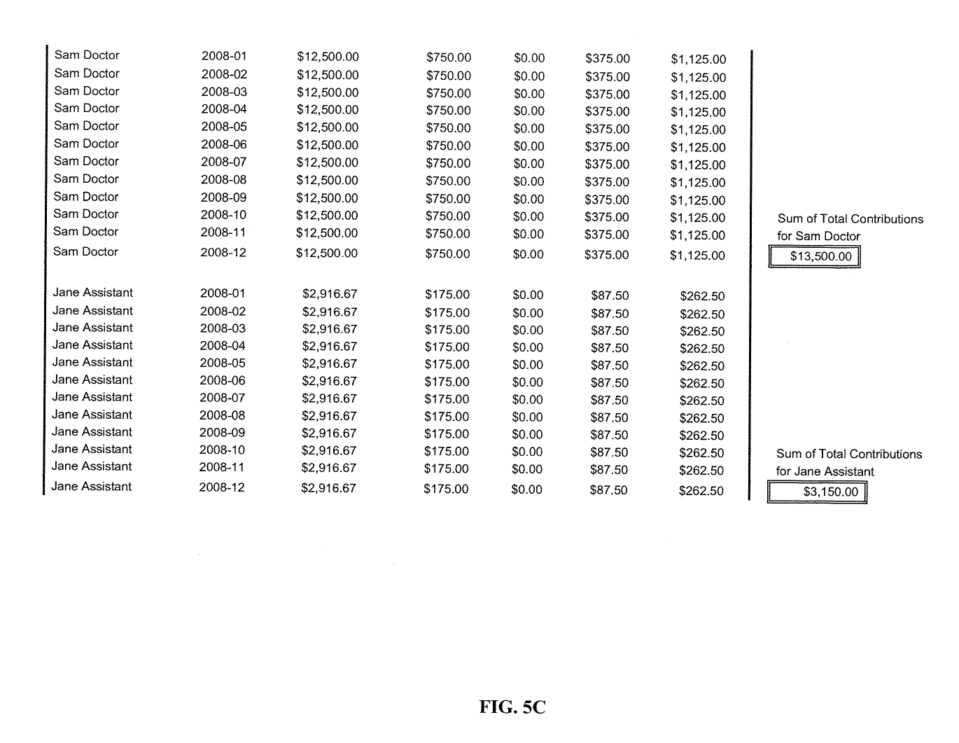

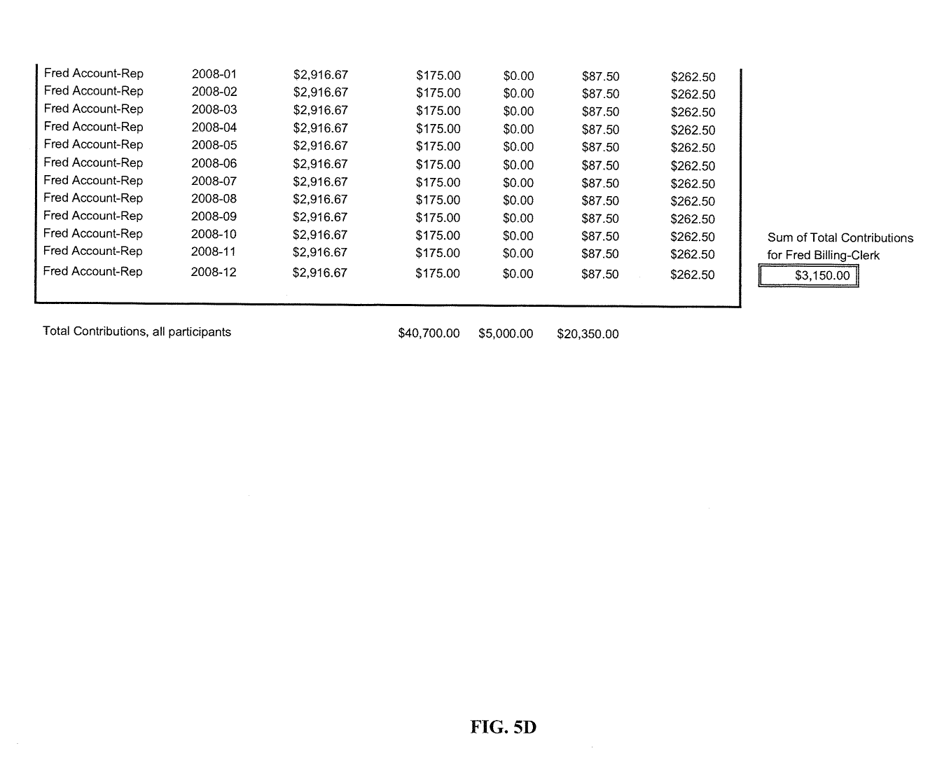

FIGS. 5A-D contains several tables representing input and output data according to the method herein. The Disability Insurance table 510 shows data elected by the plan trustee and stored in a database like Account Data 130. Those skilled in the art will recognize that the data in the table 510 are exemplary only. As previously discussed, the Expense Assumptions table contains data of a type which may be stored in a database like Account Data 130. The Census Information table 530 contains census information for five hypothetical persons that would be stored in a database like the Census and Pay Employee Information Database 100. FIG. 5B contains a Pay Data table 540 showing exemplary tabulated pay data and resultant associated calculated contributions according to the method for the five hypothetical persons shown in the Census Information table 530.

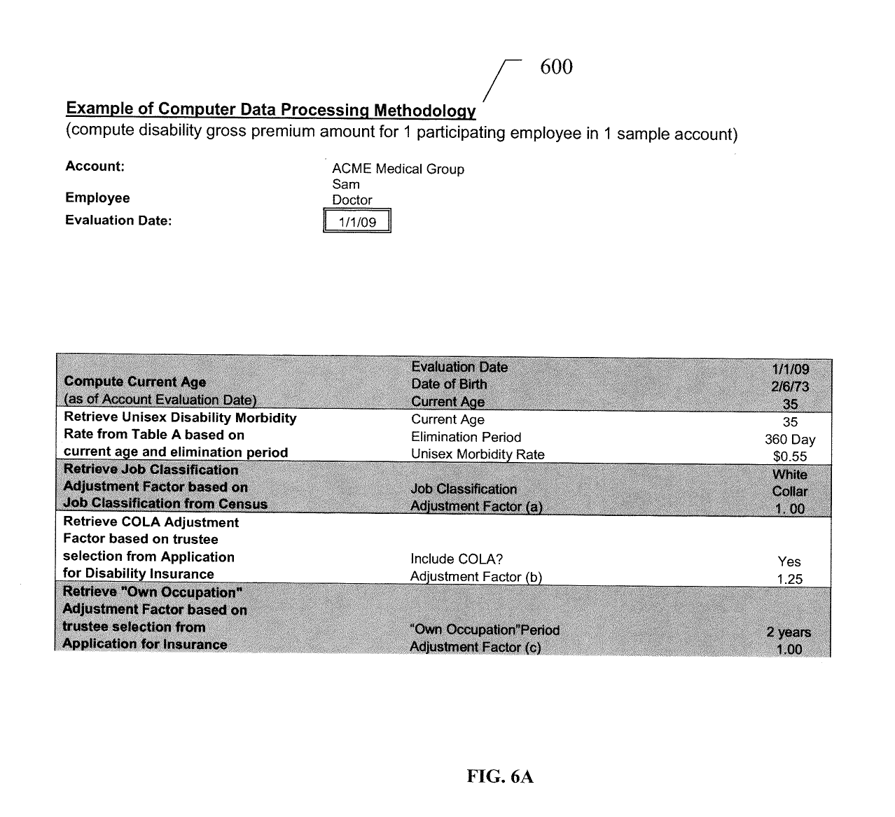

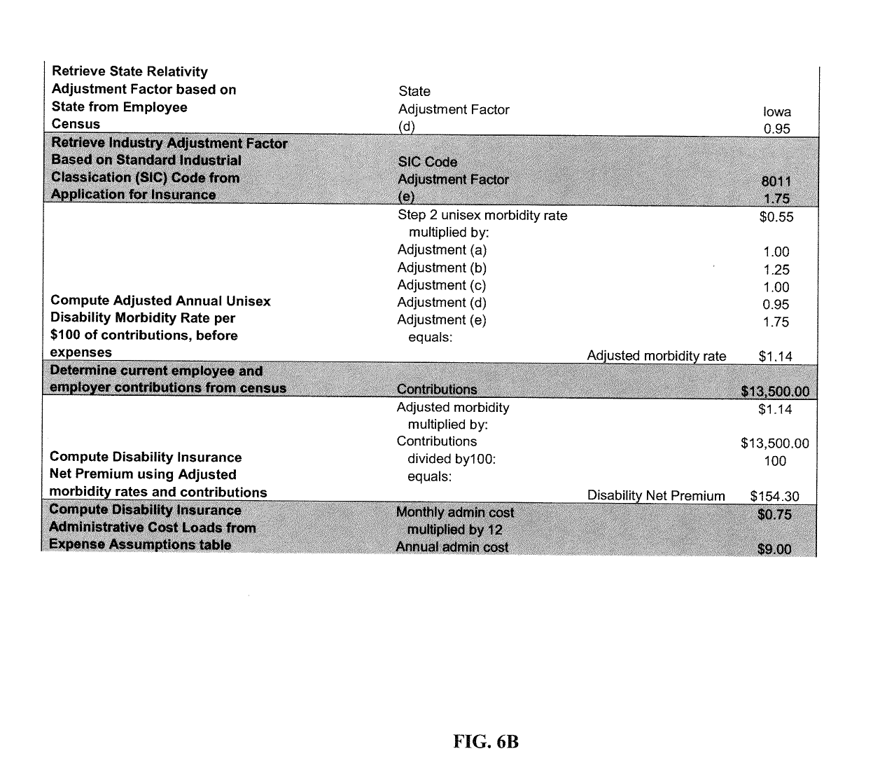

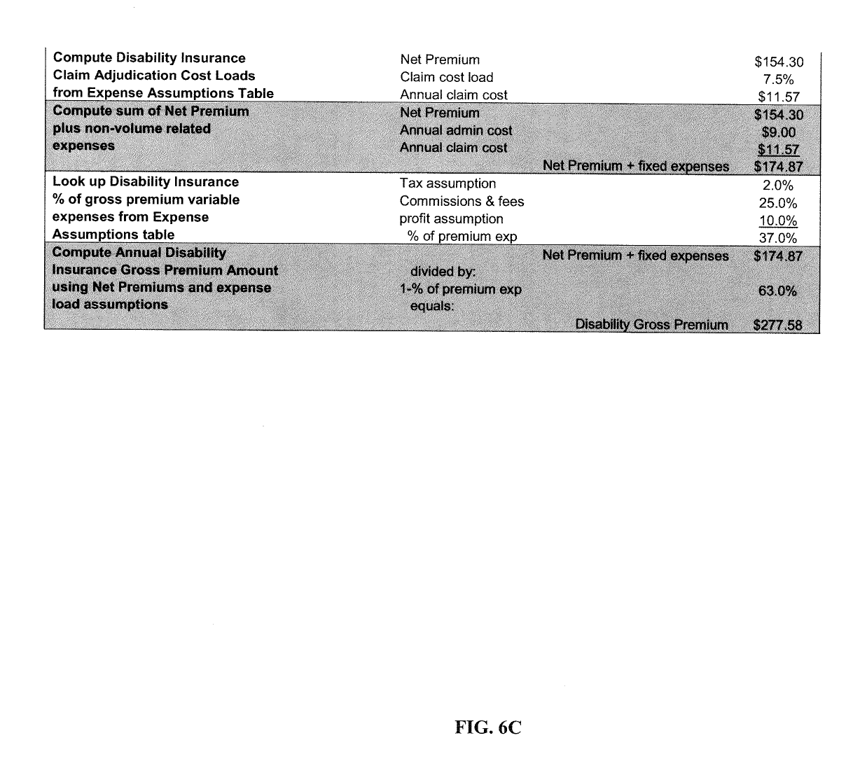

FIGS. 6A-C shows a table entitled computer data processing methodology 600. The table 600 shows exemplary input and output values produced and stored by the system 101 for one hypothetical individual listed in the Census Information table 530.

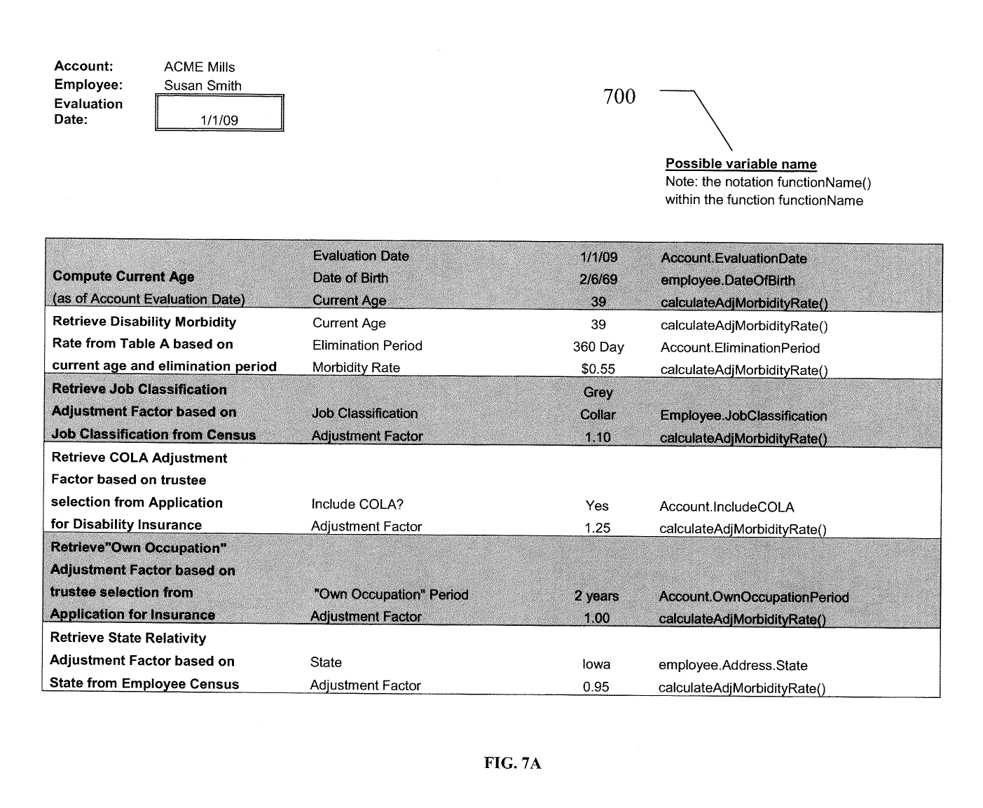

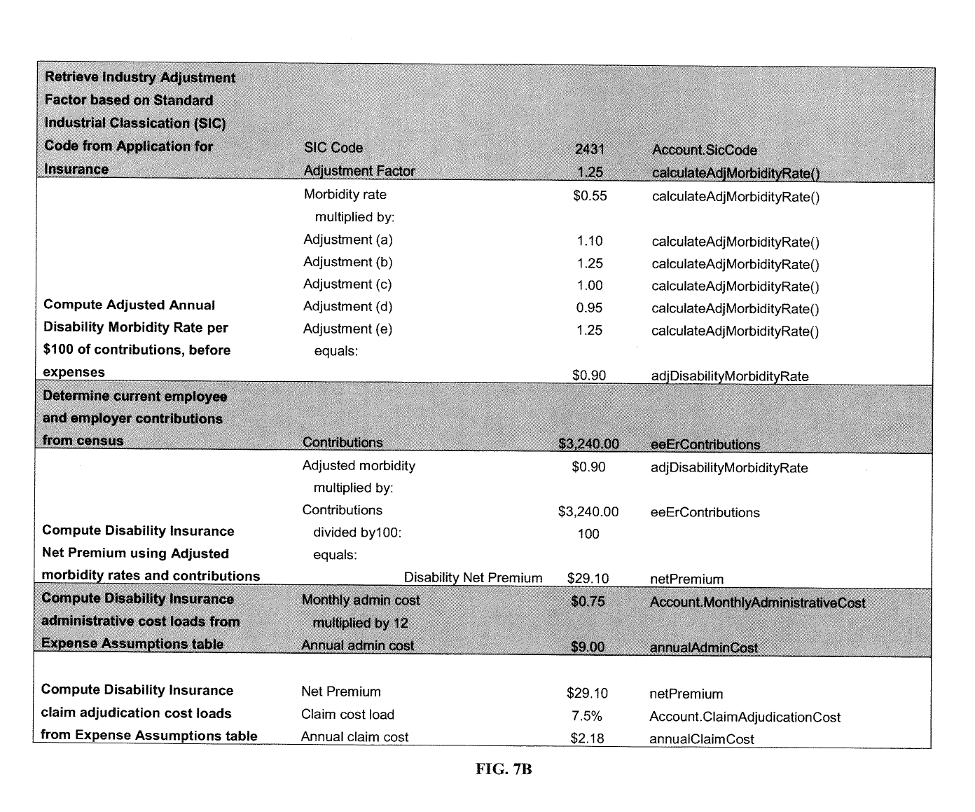

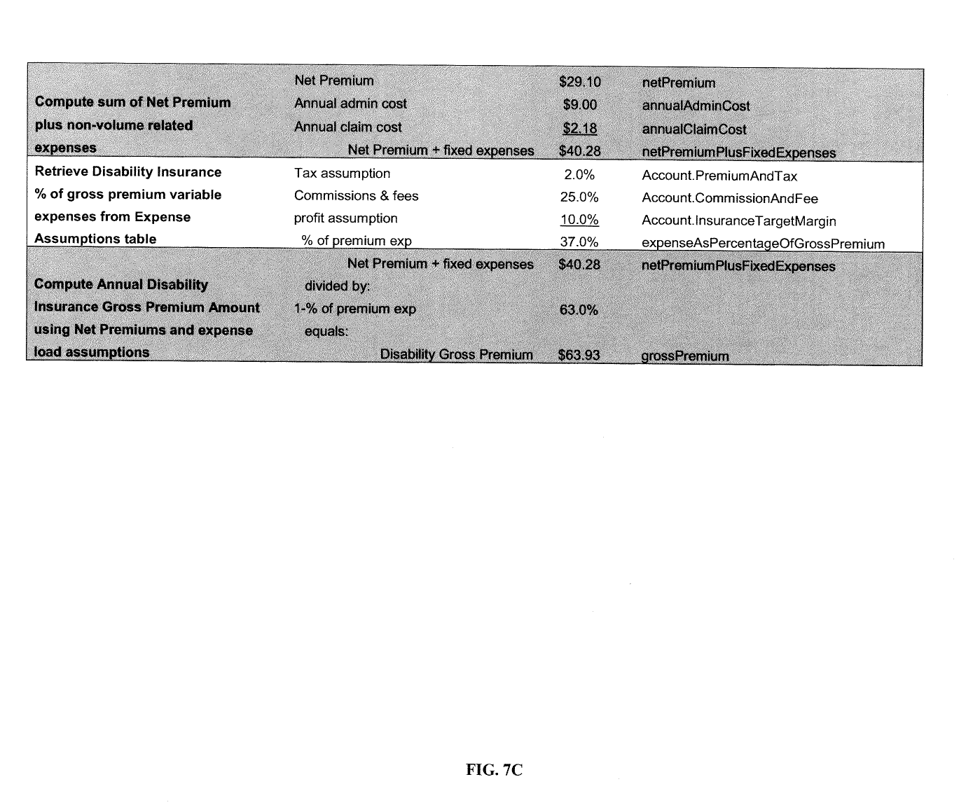

FIGS. 7 A-C shows possible input and output values for another hypothetical individual listed in the Census Information table 530. The right hand column 700 of FIGS. 7A-C shows possible variable names, as will be discussed below, for variables associated with the data listed in the middle column of FIGS. 7A-C and retrieved from the databases according to the method herein.

In one implementation of the aforementioned invention, an employer, using an employer computer with a computer interface, enters employee information into the employer computer which then transfers the information across a network to the insurance processing computer. The insurance processing computer is connected to, either physically or through a network, a plurality of databases. In this implementation, the insurance processing computer accesses the Census and Pay Database, the Risk and Adjustments Database, and the Account Database to generate a premium that is sent through the network to the employer computer. The employer, upon receiving the information, can use the user interface on the employer computer to coordinate payment of the premium. The employer has the option of sending the funds electronically through a credit card transaction, through a bank transaction and the like, or by authorizing payment of the premium through the employer's trust. The funds sent are coordinated by the insurance processing computer to the retirement account trust. Here, the funds are electronically recorded and upon retirement age of the disabled employee, the funds are electronically recorded as being paid to the now retired employee. In this implementation, the funds from the retirement account trust can be paid electronically into the retired employee's bank account or can be printed onto a computer printer and sent physically to the now retired employee.

In certain instances, the insurance processing computer is operated by a financial services company and the company, through the insurance processing computer, collects the premiums and optionally underwrites the policy. Subsequently, the premiums are sent to an employee retirement trust. The trust then pays an annuity to the disabled employee upon retirement such that the retired employee remains whole as if the employer had contributed to the 401(k) or other retirement package while the employee was off the payroll.

In certain instances, it may be preferable to have a third party administrator oversee the collection aspect of the financial services company. In such instances, the third party administrator processes the insured claims through a computer network for the employee benefit program as a separate entity, thus transferring the data between the financial services company's insurance processing computer which acts as the collection agent, and the third party administer computer which processes the claims.

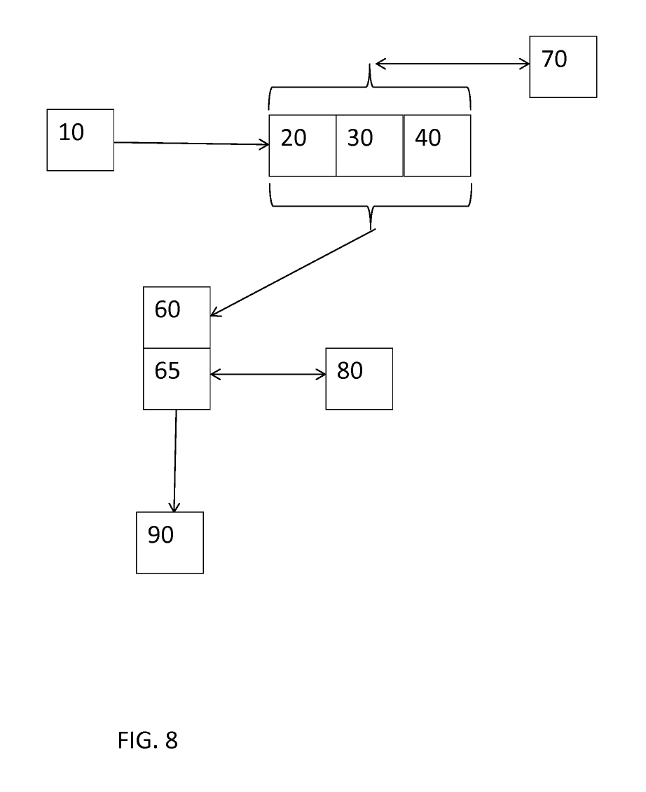

In still further aspects pertaining to FIG. 8, a third party trustee annuity advisor 80 oversees the annuity trust 65, and is responsible for adhering to the terms of the trust in the trust document. More specifically, the trustee annuity advisor holds legal title. Further, the trustee annuity advisor 80 selects the annuity provider and selects the annuity to purchase. Upon reaching retirement, the annuity is paid to the disabled recipient 90.

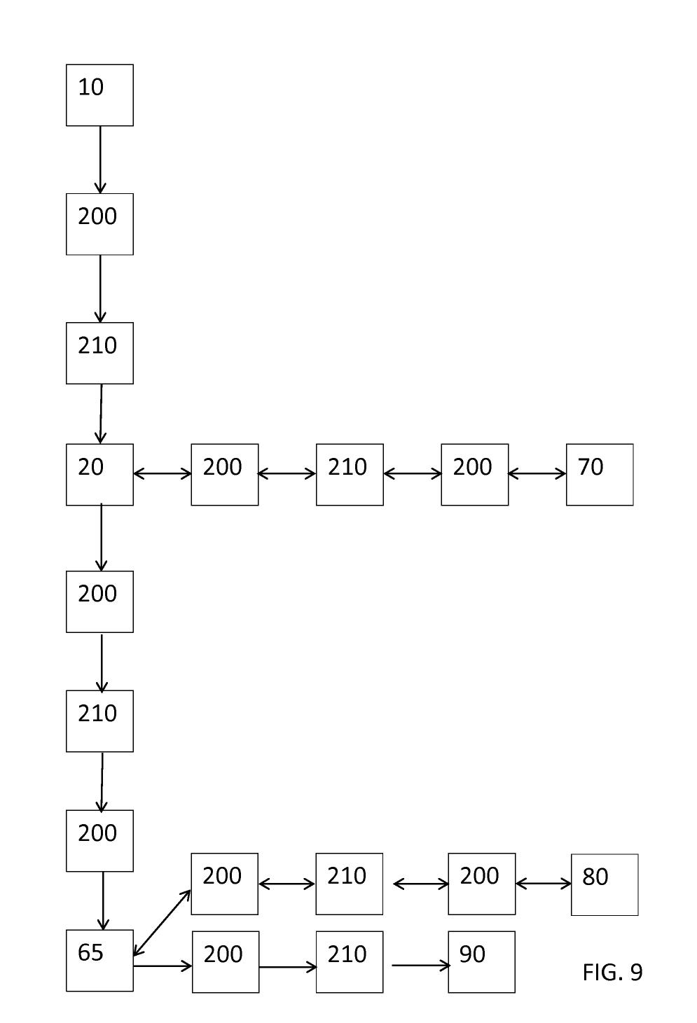

As seen in FIG. 9, the employer 10 enters data into the user interface computer 200. The data entered includes employee information such as name, address, birth date, date of hire, occupation, and job classification.

The computer interface 200 also provides a payment option to the employer such as an option to draw directly from a bank or from a credit card. The data and payment are sent through a network 210 and collected by a financial services company 20. The financial services company 20 transfers data through a user interface 200 and through a network 210 to another user interface 200 controlled by a bank 60 with an annuities trust 65. The third party annuity advisor transmits, via a user interface 200 and through a network 210, instructions to the bank 60 regarding an annuity provider and an annuity to purchase. Likewise, the bank uses a computer interface 200 and a network 210 to transfer fund directly, or indirectly with a check, into the recipient's account upon the recipient reaching retirement age.

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

The disclosure can be embodied in other specific forms without departing from its spirit or essential characteristics. A person of skill in the art should consider the described embodiments in all respects only as illustrative and not restrictive. The scope of the disclosure is, therefore, indicated by the appended claims rather than by the foregoing description. A person of skill in the art should embrace, within their scope, all changes to the claims which come within the meaning and range of equivalency of the claims. Further, we hereby incorporate by reference, as if presented in their entirety, all published documents, patents, and applications mentioned herein.

1. A method of both transmitting electronic funds on a networked computer system to a trust computer and disbursing the electronic funds from the trust computer, the method comprising the steps of:
A) initiating a data transfer via a user interface on the networked computer system to a processing computer on the networked computer system, the data comprising an age of an individual, employment information of the individual, salary of the individual and optionally other data comprising disability morbidity rates, industry adjustment factors, job classification factors, cost of living adjustments factors, own occupation adjustment factors and state relativity adjustment factors or combinations thereof; wherein upon receipt of the data, the processing computer generates a premium amount based on the data transmitted by the user interface and a disability insurance contract and sends data comprising the premium amount to the user interface via the networked computer system;
B) transferring electronic funds from the user interface to the processing computer or transmitting data comprising an authorization of a transfer comprising electronic funds from a first trust computer on the networked computer system to the processing computer;
C) having the processing computer receive data comprising the electronic funds from the user interface or from the first trust computer, wherein the electronic funds are equal to the premium amount generated by the processing computer;
D) transmitting electronic data from the user interface comprising a first conditional event to the processing computer, and optionally, transmitting electronic data from the user interface comprising a second conditional event to the processing computer;
E) transferring data from the processing computer comprising electronic funds to a second trust computer on the networked computer system upon receipt of the data comprising the first conditional by the processing computer and optionally, stopping data transfer comprising electronic funds by the processing computer to the second trust computer upon receipt of data by the processing computer indicating that the second conditional event has occurred;
F) having the second trust computer receive data comprising electronic funds from the processing computer upon reception of data comprising the first conditional event by the processing computer, and optionally, having the second trust computer stop receiving electronic funds transmitted from the processing computer upon the processing computer receiving data comprising the occurrence of the second conditional event;
a. wherein the second trust computer associates the data received by the processing computer with an account belonging to the individual
G) having the second trust computer disburse the electronic funds from an account upon a non-conditional event; and
wherein the first conditional event is a disability preventing the individual from being employed, wherein the non-conditional event is the age at which individual is eligible to receive funds from the second trust as a result of reaching retirement age as defined by the disability insurance contract.

2. The method of claim 1, wherein said disability insurance contract is a guaranteed issue basis disability insurance contract.

3. The method of claim 1, wherein said disability insurance contract is a guaranteed issue basis disability insurance contract.

4. The method of claim 1, wherein having the processing computer receive data comprising the electronic funds from the user interface via the user interface or via the first trust computer fulfills a fiduciary requirement of Section 404(c) of the Employee Retirement Income Security Act.

5. The method of claim 1 wherein if the first conditional event does not occur, data comprising electronic funds is transferred by a user interface to a retirement plan computer, and wherein the retirement plan computer electronically associates the electronic funds with the individual and wherein steps D-G do not occur.

6. The method of claim 1 wherein the disability contract is a defined contribution plan.

7. The method of claim 1, wherein the defined contribution plan is a 401 (k) plan.

8. The method of claim 1, wherein the data comprising electronic funds transferred to the second trust computer is indexed in accordance with data comprising electronic funds with maximum contribution deferrals allowed to be made to said retirement plan computer if the first conditional event does not occur.

9. A networked computer system configured to transfer information and electronic funds to a trust computer and disbursing the electronic funds from the trust computer based on at least one conditional event and at least one non-conditional event, the system comprising:
A) a user interface computer on the networked computer system;
B) a processor computer on the networked computer system;
C) a financial services computer, a first trust computer or a combination thereof on the networked computer system; and
D) a second trust computer on the networked computer system; and wherein
a user interface computer initiated electronic data transfer to the processing computer with the data comprising an age of an individual, employment information of the individual, salary of the individual and optionally other data comprising disability morbidity rates, industry adjustment factors, job classification factors, cost of living adjustments factors, own occupation adjustment factors and state relativity adjustment factors or combinations thereof results in a generation of premium amount by the processing computer according to a disability insurance contract, which is then sent as electronic data over the networked computer system to the user interface computer and wherein
the premium amount sent over the networked computer system to the user interface computer results in a user interface initiated transfer of data comprising electronic funds equal to the premium amount to the processing computer, from either transfer of said electronic funds from a financial services computer holding a personal or business bank account, or by transfer of said electronic funds from a first trust computer and wherein
the user interface computer initiates another electronic data transfer comprising a notification of a first conditional event to the processing computer causing a processing computer initiated data transfer of electronic funds to a second trust computer which then associates the electronic funds received with an account belonging to the individual, and optionally wherein the user interface initiates another electronic data transfer comprising a notification of a second conditional event to the processing computer causing the processor to stop data transfer of electronic funds to the second trust computer, and wherein
there is a second trust computer initiated disbursement of funds from the account upon the occurrence of a non-conditional event, and wherein
the first conditional event is a disability preventing the individual from being employed, the second conditional event is a return to employment by the individual and the non-conditional event is the age at which individual is eligible to receive funds from the second trust as a result of reaching retirement age as defined by the disability insurance contract.

10. The method of claim 9 wherein until the first conditional event occurs, there is a user interface computer initiated data transfer comprising electronic funds not associated with the premium amount to a retirement plan computer, and wherein the retirement plan computer electronically associates the electronic funds with the individual.

11. The method of claim 10, wherein the data comprising electronic funds transferred to the second trust computer is indexed in accordance with data comprising electronic funds with maximum contribution deferrals allowed to be made to said retirement plan computer if the first conditional event does not occur.

12. An apparatus configured to receive at least one electronic data stream and configured to disburse electronic data upon a non-conditional event, wherein the at least one data stream comprises:
electronic funds associated with an entity, age of the entity, and a date at which a non-conditional event will occur; wherein the data stream is transferred from a processing computer configured to transmit said data stream; and wherein the data stream is transmitted to and received by the apparatus upon a first conditional event, and if a second conditional event occurs, the processing computer ceases transmitting the data stream; and
wherein the processing computer is configured to receive data comprising the first conditional event and optionally the second conditional event from a user interface device configured to transmit said data; and
wherein the processing computer transmits the at least one data stream to the apparatus, after receiving electronic funds from:
i. the user interface, or
ii. a trust computer configured to transmit electronic funds to the processing computer after receipt of data comprising an authorization to transmit said funds by the user interface, or
iii. a financial institution computer configured to transmit electronic funds to the processing computer after receipt of data comprising an authorization to transmit said funds by the user interface, or
iv. a combination thereof; and
wherein the receipt of said electronic funds by the processing computer occurs after:
i. the user interface transmits entity data comprising environmental, biological and financial information to the processing computer;
ii. the processing computer runs an actuarial model based on the entity data, a disability insurance contract, and optionally other data comprising disability morbidity rates, industry adjustment factors, job classification factors, cost of living adjustments factors, own occupation adjustment factors and state relativity adjustment factors or combinations thereof and generates a premium;
iii. the processing computer transmits data comprising the premium to the user interface; and
iv. the user interface transmits the electronic funds or authorizes the transmittal of the electronic funds; and
wherein the electronic funds correspond to the premium transmitted by the processing computer to the user interface.

13. The apparatus of claim 12, wherein the entity is an employee.

14. The apparatus of claim 13, wherein the first conditional event is a date on which the employee becomes disabled, the second conditional event is a date on which the employee is able to return to work, and the non-conditional event is a date on which the employee is able to receive retirement benefits.

15. The apparatus of claim 14, wherein the entity data comprises age of the employee before the generation of the premium, employment information of the employee before the generation of the premium, and salary of the employee before the generation of the premium.
